(19) United States
(12) Patent Application Publication
(10) Pub. No.: US 2023/0241867 A1
(43) Pub. Date: Aug. 3, 2023

(54) FIRE PROTECTION GLAZING INCLUDING A SECONDARY SEAL HAVING INTUMESCENT AND COOLING FIRE PROTECTION PROPERTY

(71) Applicant: Saint-Gobain Glass France, Courbevoie (FR)

(72) Inventors: Nikita Reinhardt, Kirrwiller (FR); Norbert Schwankhaus, Baesweiler (DE); Jerome Korus, Aachen (DE)

(21) Appl. No.: 18/012,430

(22) PCT Filed: Jun. 28, 2021
(86) PCT No.: PCT/EP2021/067618

§ 371 Date: Dec. 22, 2022

(30) Foreign Application Priority Data
Jun. 26, 2020 (EP) 20182655.9

(51) Int. Cl. B32B 17/10; B32B 3/18

(52) U.S. Cl. CPC B32B 17/10036; B32B 17/10311; B32B 17/10302; B32B 3/18; B32B 2307/3065; B32B 2307/308; B32B 2313/04

(57) ABSTRACT

Fire protection glazing made of two or more glass panes spaced apart from each other by a spacer. A fire protection material and the spacer are arranged in an intermediate space between the two glass panes. A secondary seal encloses the fire protection material and the spacer in the intermediate space. The secondary seal thereby has an intumescent and a cooling fire protection property. Exclusively the fire protection material, the spacer, optionally having an optional spacer attachment for attaching the spacer to the glass pane, and the secondary seal can be arranged in the intermediate space between the two glass panes.

### BACKGROUND OF THE INVENTION

### Field of the Invention

The invention relates to the field of fire protection glazing including at least two glass panes and a fire protection material arranged therebetween.

### Description of Related Art

Fire protection glazing particularly means an at least partially transparent part of a fire protection glazing, that is, fire protection glazing free of any frames, mounting elements, and/or other elements enclosing the transparent part. Or, put another way, fire protection glazing particularly means a fire protection panel having a sandwich-like structure without any frame or mounting element.

Fire protection glazing comprising fire protection material enclosed between glass panes is already known in various embodiments. In order to retain the fire protection material between the glass panes, known fire protection glazings include a seal. The seal shields the fire protection material from external influences and protects said material against aging processes, for example.

Known seals often include a spacer arranged between the glass panes and ensuring that the glass panes are spaced apart. The spacer is also referred to as the primary seal.

Known seals often include a secondary seal as well for immovably attaching the glass panes spaced apart by the spacer to each other. The secondary seal is also referred to as the edge seal.

The spacer and the secondary seal together enclose the fire protection material between the glass panes.

The known fire protection glazings have the disadvantage that edges of the fire protection glazing can have lower efficiency with respect to fire protection than parts of the fire protection glazing further away from the edges. The fire protection effect of the fire protection mass cannot take effect all the way to the edge. The edges of the fire protection glazing are also often particularly severely loaded parts of the fire protection glazing. For example, high temperatures can arise at the edges of the fire protection glazing in case of fire. As another example, thermal radiation can penetrate more intensively at the edges of the fire protection glazing in case of fire. For example, flames can find a way around the fire protection glazing at the edges of the fire protection glazing.

Because the sealing takes up space, the fire protection glazing cannot be introduced between the glass panes all the way to the edges of the fire protection glazing. The material of the spacer and/or seal can also be designed a weak point with respect to fire protection, for example, because the seal itself burns or emits combustible substances.

Tested fire protection elements (such as the fire protection glazing according to the invention) must, in order to be accredited as such, fulfill particular standards and requirements under standardized fire resistance tests. Such standards are provided by the European standard EN 1363 (as of December 2013) and EN 1364 (as of December 2013). EN 1363 establishes general fundamentals for determining the duration of fire resistance for various types of components exposed to fire under standardized conditions. According to EN 1363, the temperature in the fire space, that is, on the side of the fire protection element facing toward the fire, is already 700° C. after 15 minutes. EN 1364 defines methods for determining the fire resistance duration of non-structural components. The standard DIN 4102 relates to the fire behavior of construction materials.

The fire resistance or flame resistance can be considered as the capability of a component to form an effective barrier against the spread of flames, smoke, and hot gases, and/or to prevent the transmission of thermal radiation. A fire resistance duration is defined as a minimum duration in minutes, during which the fire protection element meets particular (particularly standardized) requirements during testing according to standardized testing methods under defined boundary conditions (EN 1364 and EN 1363) and at a particular temperature load. Said (particularly standardized) requirements are listed and defined in EN 13505, for example, and enable classifying fire protection elements. The fire resistance duration is thus a measure of the utility of the design in case of fire. In other words, during the fire resistance duration, the passage of fire through the fire protection element is prevented, that is, integrity under fire conditions (EN 1363 and EN 1364) is ensured. In addition to integrity, the fire protection element can fulfill further functions, such as thermal insulation.

The fire resistance duration, during which the fire protection element tested according to the standards listed above fulfills corresponding criteria and requirements, allows the fire protection element to be classified. Fire protection elements can be classified as follows according to the standard EN 13501 (as of December 2013). The following classes are differentiated, for example:

Classification E (integrity) classifies construction elements with a fire separating function according to how long said elements ensure impermeability to smoke and hot gases.

Classification I (insulation) specifies the thermal insulation properties in case of fire (see below the explanation for classification EI).

Classification EW (thermal radiation) relates to construction elements having a fire separating function with reduced thermal radiation (<15 kW/m²). Such construction elements can remain transparent or form an opaque protection layer in case of fire, for example.

Classification EI (integrity & insulation) specifies construction elements having a fire separating function according to how long said elements meet the requirements of class E and additionally provide insulation against thermal effects (radiation, heat conduction). This is indicated by the fire resistance duration, during which the average temperature rise on the cold side must not exceed 140 K and the maximum temperature rise on the cold side must not exceed 180 K. The EI classification can thus be applied only if the outside of the fire protection construction element remains below 200° C. on the side facing away from the fire (cold side) over a certain period of time (fire resistance duration), that is, the cold side heats up by a maximum of 180 K. For example, a fire protection construction element of class EI 30 will resist a fire for at least 30 minutes, and a fire protection construction element of class EI 90 will resist a fire for at least 90 minutes, and limits the temperature on the cold side to a maximum of 200° C. during said time period. Classification of EI 20 and higher are generally achieved in the prior art by a protection layer being opaque in case of fire.

Classification times are indicated in minutes for each classification, wherein the classification times: 10, 15, 20, 30, 45, 60, 90, 120, 180, 240 or 360 are used. The fire resistance duration is thus defined as at least 10 minutes. In general, a fire protection element thus fulfills the corresponding criteria or requirements for fire resistance duration for at least 10 minutes (see classification—EN 13501). The minimum criterion is thereby integrity. A fire protection element must therefore be able to be classified at least as E10.

Particularly at the edges of the fire protection glazing, depending on the embedding of the fire protection glazing in the surrounding area thereof (wall, mounting element, frame, further adjacent glazing, and the like), a weak protection effect can be seen in case of fire. Good, effective fire protection is especially important at top edges of fire protection glazing, where heat, smoke, hot gas, and/or flames can build up in case of fire due to convection and other reasons. Particularly due to expansion of the embedding due to fire, part of the fire protection glazing can come into direct contact with the flames (such as the secondary seal and/or spacer).

Often, therefore, known fire protection glazing must be embedded with difficulty in the surrounding area for good overall fire protection properties. Frames or mounting elements for known fire protection glazing therefore comprise additional elements having intrinsic fire protection effects, for example. This results in expensive and complex designs for frames and mounting elements for known fire protection glazing. Installation, that is, mounting and installing the known fire protection glazing, is also thereby complex and difficult.

Fire protection glazing having additional fire protection elements at the edges thereof is already known. One such known fire protection glazing is disclosed in EP0970930, for example. The fire protection glazing described therein comprises both a spacer and a seal, as well as an expanding band, at the edges thereof between two glass panes. The expanding band can increase the volume thereof by at least a dozen times at high temperatures. In this manner, any gaps between the fire protection glazing and adjacent components (such as a wall or a further fire protection glazing) are to be closed in this manner in order to block out hot gases or flames.

Such previously known fire protection glazing has the disadvantages of only being able to be produced with substantially higher effort and substantially higher cost, because additional fire protection elements such as the expanding band must be produced, stored, and additionally installed. The design of the fire protection glazing is also complicated and thereby prone to production errors. Particular effort must also be expended for installing the fire protection glazing.

DE 20303253 relates to the implementation of a spacer profile. DE 60004041 is focused on a butyl-based adhesive composition for use as an adhesive spacer. EP 1205524 relates to a butyl sealant for fire protection purposes. The butyl sealant is thereby used as a spacer.

### SUMMARY OF THE INVENTION

The object of the invention is therefore to produce a fire protection glazing of the type indicated above for at least partially eliminating at least one of the disadvantages indicated above.

The object is achieved by a fire protection glazing having the features of the corresponding independent claim. Advantageous embodiments can be found in the dependent claims, the description, and/or the figures.

The fire protection glazing according to the invention includes two or more glass panes spaced apart from each other by a spacer. A fire protection material and the spacer are arranged in an intermediate space between the two glass panes. A secondary seal encloses the fire protection material and the spacer in the intermediate space. The secondary seal thereby has an intumescent and a cooling fire protection property.

In the scope of the present application, the term “comprise” is used to name one or more components (wherein further components, not named, can also be present). In other words, “comprise” can also be understood to mean “include” (without thereby being exclusive, as with “made of . . . ”). The term “comprise” is thereby expressly not to be understood as a spatial enclosing or spatial surrounding or enveloping. The terms “enclose” or “envelop” are used for the latter in the context of this application.

The term glass pane, in the context of the present invention, refers generally to a transparent pane of glass-like material. A glass pane can comprise material based on silicon oxide. However, a transparent pane of based on a polymer is also referred to as a glass pane, for example comprising polycarbonate and/or poly(methyl methacrylate) (PMMA; acrylic glass). Some partially crystalline “glass” (ceramic glass) also falls under the term glass pane.

The term “fire protection glazing” is therefore functional and not to be understood as limited to particular materials (specifically: glass in a more restricted sense), but rather expressly also includes structures having transparent or translucent panes made of the materials listed above as well as others.

Fire protection material means material, the properties of which change in case of fire, thereby limiting, reducing, and/or preventing the spread of fire. Typical examples of a fire protection material are materials based on silicate or hydrogel for forming insulation against thermal effects (radiation, thermal conduction) in case of fire. For example, a fire protection material can protect against the spread of fire by becoming opaque, absorbing (thermal) energy, and/or forming thermally insulating properties.

The expression “in case of fire” means “in the event of a fire”. That is, under conditions prevalent in the event case of a fire. This can refer to a correspondingly high temperature range, correspondingly high thermal radiation, the presence and/or absence of a particular gas, and/or the presence of flames and/or smoke.

The spacer is an element arranged between the glass panes and ensuring that the glass panes are spaced apart.

Fire protection glazing of the type indicated above can comprise two, three, or more glass panes and correspondingly comprise one, two, or more intermediate spaces, each having a spacer and fire protection material. For example, when producing such multilayer fire protection glazing, after applying a spacer to a glass pane, the next glass pane is set in place, and such a layer packet is pressed together to a desired specified thickness of the intermediate space by means of a mechanical press. The specified thickness of the intermediate space must not change when the layer packet is subjected to a new pressing procedure after applying a next spacer in order to press the next intermediate space together to the desired specified thickness. This is ensured by the spacer. The spacer is also intended to retain the stability thereof and the function of spacing apart in case of fire.

The spacer thus ensures a particular spacing between the glass panes. This means particularly that the spacer maintains the glass panes at a constant distance from each other at least for a horizontal storing of the fire protection glazing. In other words, the spacer in particular maintains the glass panes at a distance from each other up to a pressure corresponding to at least a pressure exerted by an intrinsic weight of a glass pane.

This means that, in a fire protection glazing ready for application, the spacer arranged between the glass panes maintains the glass panes spaced apart from each other by the same distance, even if a minimum pressure is exerted on the glass panes in the direction of the intermediate space. In other words, the spacer is mechanically resistant to the minimum external pressure on the flat sides of the glass panes of the fire protection glazing, such that the glass panes comprise an unchanged distance from each other. The minimum pressure thereby corresponds to at least a pressure potentially exerted by an intrinsic weight of a glass pane.

The spacer can be a single part or multipart in design. The spacer can itself adhere to one or more glass panes, and/or the spacer can be attached—particularly adhesively—to one or more glass panes. The spacer defines a spacing between the glass panes and thus a thickness of an intermediate space between the glass panes.

The secondary seal can be an element for immovably attaching the glass panes spaced apart by the spacer to each other. This means that the bonding is brought about by the secondary seal. The spacer therefore need not necessarily be adhered to the spaced-apart glass panes. In other words: no additional adhesive is necessary between the pane and the spacer. The fire protection glazing can be free of adhesive between the glass pane and the spacer.

The secondary seal thus has the task of fixing the glass panes, spaced apart from each other by the spacer, in said position relative to each other. This particularly means that the secondary seal adheres the glass panes to each other.

The secondary seal particularly can be designed as a water vapor barrier.

The spacer and the secondary seal together enclose the fire protection material between the glass panes in a gas-tight manner. The spacer alone particularly cannot enclose the fire protection material in a gas-tight manner.

Gas-tight means that the secondary seal does not allow any water vapor and particularly not any air or oxygen to pass through.

The secondary seal encloses the fire protection material and the spacer in the intermediate space of the glass panes. Enclosing in the intermediate space of the glass panes means that the glass panes and the secondary seal together fully spatially envelop the fire protection material and the spacer.

In order that the secondary seal can immovably connect or immovably attach the glass panes to each other, good bonding of the secondary seal at the glass panes is necessary.

The secondary seal has good glass adhesion.

In particular, good glass adhesion allows a gas-tight connection/bond to be formed with a glass pane.

The secondary seal is particularly arranged entirely in the intermediate space between the glass panes.

The secondary seal can be arranged at least partially in the intermediate space between the glass panes.

For example, the secondary seal can be arranged completely outside of the intermediate space, such as connecting the end faces of the glass panes.

The secondary seal, also referred to as the secondary seal, can be different from the spacer. In other words: the secondary seal can be designed separately from the spacer. The secondary seal and the spacer are thereby designed as separate elements. Separating the spacing and the adhesive properties can thereby be made possible. In other words: the secondary seal and the spacer are two differentiated elements and independent of each other. The fire protection glazing does not comprise any further elements surrounding or enclosing the intermediate space (also referred to as the intermediate pane space) in addition to the spacer and the secondary seal.

The spacer can be free of any intumescent fire protection property. The glass panes are thus not pressed apart by the internal spacer in case of fire. The geometry of the fire protection glazing can thus be maintained. Thus, the spacer does not intumescent, but rather the secondary seal does so.

The secondary seal can be designed as a single element. In other words: the secondary seal can be a single part, that is, not two or more parts. The assembling or construction of the fire protection glazing can thereby be facilitated, because only one element must be placed around the spacer as the secondary seal. This reduces the number of work steps required for assembling the fire protection glazing, because a plurality of elements is not needed, but rather only one single element needs to be placed as the secondary seal as the closure around the spacer.

The secondary seal can substantially circumferentially cover particularly at least 50% of the circumference of the fire protection glazing. The secondary seal can be a single component and/or homogeneous. It is also possible that the secondary seal comprises a homogeneously distributed mixture of a plurality of components. The secondary seal can comprise solid inclusions, for example integrated in the single element.

The secondary seal has a intumescent fire protection property, and the secondary seal additionally has a cooling fire protection property. This means that the secondary seal comprises both a cooling fire protection property and a intumescent fire protection property.

The combination of intumescent and cooling fire protection properties of the secondary seal has the advantage that a fire protection glazing achieves fire protection based on two different effects. Depending on the fire conditions, the intumescent effect, the cooling effect, or a combination of both can bring about high efficiency. The fire protection glazing thus has good fire protection for a wide range of different conditions and situations. The fire protection glazing thereby has a high level of robust fire protection.

The combination of intumescent and cooling fire protection properties of the secondary seal allows fire protection glazing having very particular fire protection characteristics for particular fire protection requirements to be provided by means of targeted selection and combination of materials having intumescent and cooling fire protection properties. In other words, due to the many potential combinations of materials having different fire protection properties (intumescent and/or cooling), a fire protection glazing having very particularly desired characteristics can be customized.

Particularly intumescent and cooling fire protection properties can advantageously complement and/or support each other.

For example, gas can be released due to decomposition of a first material having a cooling fire protection property due to absorbing energy for decomposition. Said gas, in turn, can support a second material having a intumescent fire protection property for forming the foam, in that the gas released by the first (cooling) material is additionally absorbed by foam bubbles of the foam designed by the second material. Thus, thanks to the first (cooling) material, more foam and/or foam having larger foam bubbles arises.

A cooling fire protection property is a property of the secondary seal having an active cooling effect in case of fire—for example by converting energy—and protecting in case of fire by means of said cooling effect.

This means that in a fire, the secondary seal having cooling fire protection properties brings about a fire protecting effect with respect to the temperature: an absolute temperature is reduced and/or a temperature increase is reduced or prevented. This is referred to in the context of the present invention as a cooling fire protection property, or also as actively cooling.

Thermal energy is particularly converted into an energy different from thermal energy.

The converting of energy is particularly the main effect constituting the cooling fire protection property.

A cooling fire protection property can be achieved by an endothermic process, separating water or another liquid and/or by evaporating water or another liquid (enthalpy of evaporation). Energy is converted in this manner, that is, an actively cooling effect is achieved. Converting energy can also be referred to as taking up or absorbing energy or consuming energy. When converting (thermal) energy, said (thermal) energy is transmuted into a different form of energy, and thus removed from the system.

A purely insulating effect for reducing or preventing thermal transfer or thermal transport, in contrast, is not a cooling fire protection property. Such an insulating effect can indeed reduce or prevent a temperature rise by reducing or preventing the thermal transfer and could potentially thus even be referred to as passive cooling. For the insulating effect as well, no active cooling effect is achieved, for example, no energy is converted. And for this reason, the insulating effect in the context of the present invention is understood to be a non-cooling fire protection property.

The secondary seal can comprise materials as listed in the following table in order to achieve a cooling fire protection property (x and y thereby stand for arbitrary numbers):

| | |
|---|---|
| Metal hydroxides | Al(OH)₃, Mg(OH)₂, Ca(OH)₂ |
| Hydrous metal salts | General formula |
| | (Metal)ₓ(Salt)_{y}x(H₂O) |
| | Can be at least one salt and one metal |
| | combination |
| | Non-exhaustive list of examples below |
| | Hydrous carbonate salts |
| | Magnesium carbonate polyhydrate: |
| | MgCO₃•xH₂O |
| | Huntite: Mg₃Ca[CO₃]₄ |
| | Mg₅(CO₃)₄(OH)₂•xH₂O (x = 4: |
| | Hydromagnesite) |
| | Deposits of hydromagnesite and huntite |
| | (“ultracarb”) |
| | Magnesium carbonate hydroxide- |
| | pentahydrate: (MgCO₃)₄Mg(OH)₂•xH₂O |
| | (MCHP) |
| | NaAI(OH)₂CO₃ (Dawsonite) |
| | Potassium carbonate: K₂CO3•xH₂O |
| | Hydrous sulfate salts |
| | MgSO₄•xH₂O |
| | Gypsum: CaSO₄•xH₂O |
| | Hydrous sulfite salts |
| | Nitrogen sulfite: Na₂SO₃•xH₂O |
| | Hydrous boron compounds |
| | Zinc borate |
| | Boron phosphate |
| | Boron siloxane |
| | B₂O₃ |
| | Hydrous phosphorous compounds |
| | Salts of phosphoric acid |
| | Magnesium phosphate polyhydrate: |
| | Mg₃(PO₄)₂•xH₂O |
| | Aluminum phosphate polyhydrate |
| | Manganese hypophosphite |
| | Cerium phosphate |
| Other inorganic, | Sodium acetate polyhydrate: |
| hydrous compounds | CH₃COONa•xH₂O |
| | Boehmite: AlO(OH) |
| | Magnesium chloride |
| | Silsesquioxane, sepiolite (meerschaum), |
| | zinc and nickel salts, salicylaldehyde, |
| | salicylaldoxime, colemanite |
| | ZnS, ZnSn(OH)₆, ZHS |
| | CeNO3 |
| Organic, hydrous | Salts of organic acids: |
| compounds | Salts of citric acid |
| | Salts of tartaric acid |
| | Salts of mesotartaric acid |
| | Salts of gluconic acid |

The secondary seal can comprise one or more materials from the above table for achieving the cooling fire protection property thereof.

An intumescent fire protection property is a property of the secondary seal to intumescent/foam in the event of a fire and thereby protecting in case of fire. This means that in a fire, the secondary seal forms foam having a protective function in case of fire. Foam refers to gaseous bubbles enclosed by solid or liquid walls.

The intumescent fire protection property is based on an ability of material to swell, intumescent or foam up when high temperatures occur and to form a thermally insulating foam.

The foam formed due to the intumescent fire protection property can reduce or prevent a temperature rise by means of an insulating effect reducing or preventing thermal transfer or thermal transport, particularly on a side facing away from the fire (also referred to as the cold side or protected side).

The foam formed by the intumescent fire protection property can in case of fire at least partially close any gaps between the fire protection glazing and adjacent components (such as a wall or a further fire protection glazing) in order to at least partially block the path of hot gases or flames.

The foam can have the effect of reducing or eliminating the oxygen available for the flames. The foam can thus have a fire protection property because said foam reduces or eliminates fuel and/or oxygen. The foam can, so to speak, not leave any room for flames. The foam can spatially limit flames, for example penetration of flames into a region of the embedding of the fire protection glazing in the surrounding area thereof. For example, foam can thus even partially or completely suffocate flames.

The fire protection property of the foam formed is the main effect of the foaming fire protection property. A potential fire protection effect of the process of foaming up as such is negligible in comparison.

In other words: During foaming/intumescing, i.e. during the formation of the foam formed by the intumescent fire protection property, a comparatively slight amount of energy can be absorbed or converted. The effect is, however, negligible in comparison with the effect of the fire protection property of the fully formed foam. The intumescent fire protection property is thus referred to in the context of the present invention as not actively cooling.

The intumescent fire protection property particularly combines intumescent of the material and carbonizing the material. This can take place at the surface of the secondary seal.

By carbonizing, a physical barrier arises between the solid body and the gas phase causing thermal and material transport. In other words, the carbonized layer acts in a thermally insulating manner and reduces or prevents materials from passing through.

The carbonizing is a complex process based on both chemical and physical properties of the carbonizing material.

The secondary seal can comprise a polymer-based matrix. The polymer-based matrix comprises epoxide, polyurethane, silicone, polysulfide, acrylic, and/or a material forming a hot melt, such as butyl. The matrix can, in turn, comprise organic and/or inorganic material having an intumescent fire protection property.

The advantage of the fire protection glazing according to the invention is that the fire protection glazing has good fire protection properties due to both the intumescent and the cooling fire protection function of the secondary seal. At the same time, the structure of the fire protection glazing is simple, and does not require additional elements.

The fire protection glazing makes additional fire protection elements unnecessary, although additional fire protection glazing is brought about.

The edges of the fire protection glazing particularly comprise good fire protection properties. Particularly at the edges of the fire protection glazing, good fire protection properties are of great advantage, because a weak fire protection effect often is present at the edges themselves or between the edges and adjacent components. In other words, the fire protection glazing according to the invention advantageously has a good fire protection effect at the edges of the fire protection glazing and thereby in the region of the embedding of the fire protection glazing in the surrounding area thereof.

Particularly the top edges of fire protection glazing, exposed to particularly strong effects of the fire in case of fire, have a good fire protection effect due to the intumescent and cooling secondary seal.

Installing the fire protection glazing having a intumescent and cooling secondary seal enables simple and inexpensive assembly in the frame system without additional intumescent or cooling bands. The simple structure makes the fire protection glazing robust and less subject to installation errors. The fire protection glazing can be installed without additional effort.

Because the fire protection glazing according to the invention has good fire protection properties at the edges thereof, the surrounding area of the installed fire protection glazing and particularly a mounting element or a frame for the fire protection glazing can be kept simple and designed without additional fire protection elements and/or measures, without thereby weakening the fire protection. This allows using inexpensively produced, simple, and robustly constructed elements adjacent to the fire protection glazing. The use and assembly of the fire protection glazing can thereby be simplified. The overall construction (fire protection glazing and the surrounding area thereof) can be kept simple, having an advantageous effect on the production, installation, and maintenance costs of the overall construction.

Tests have indicated that the fire protection glazing according to the invention (that is, having a secondary seal having intumescent and cooling fire protection properties) brings about significantly better fire protection under identical conditions in comparison with an identical double-glazed fire protection glazing filled with the same fire protection material, but having an secondary seal without intumescent and/or without cooling fire protection properties. A corresponding benchmark test is described below and in FIG. 3.

Exclusively the fire protection material, the spacer, and the secondary seal are optionally arranged in the intermediate space between the two glass panes. An optional spacer attachment for attaching the spacer on the glass pane can be arranged in the intermediate space.

Spacer attachment refers to attaching means for attaching the spacer on one or more glass panes. For example, adhesive can serve as the spacer attachment.

By arranging exclusively the fire protection material, spacer (optionally having a spacer attachment), and secondary seal in the intermediate space, the fire protection glazing comprises few elements in the intermediate space. This facilitates the production of the fire protection glazing and allows low production costs.

By eliminating additional elements in the intermediate space, the intermediate space can be filled to the edge of the fire protection glazing with fire protection material. A compact seal, comprising only the spacer (optionally having a spacer attachment) and secondary seal, makes it possible for the intermediate space to be filled with a large amount of fire protection means, having a positive effect on the fire protection properties of the fire protection glazing. A large amount of fire protection means can achieve a high fire protection effect. A large amount of fire protection means at the edges or only small edges without fire protection means brings about a good fire protection effect, especially in the important edge region of fire protection glazing.

Having few elements in the intermediate space, the fire protection glazing can comprise a large transparent region. This is because the fire protection material in the intermediate space is transparent before a case of fire, that is, transparent to light at wavelengths in a range visible to the naked human eye. The spacer and secondary seal are typically not transparent. For a compact design of the spacer and secondary seal, the non-transparent edge of the fire protection glazing can be kept small. In addition to technical advantages (such as good visibility, large viewing angles, good light transmission, good architectural integration, slight surface texturing), said design also has commercial advantages (better selling points) and esthetic advantages.

Alternatively, further elements can be arranged in the intermediate space.

The secondary seal is optionally arranged in a region of the intermediate space adjacent to the end faces of the glass panes.

In other words, the secondary seal fills the outermost edge of the intermediate space of the fire protection glazing, out to a range adjacent to the end faces of the glass panes. The secondary seal can thereby be arranged flush with the end faces of the glass panes in the intermediate space. Or, the secondary seal is set back slightly inwards into the intermediate space. Alternatively, the secondary seal protrudes slightly past the end faces of the glass panes. Slightly, in the present context, means a maximum of 5 millimeters. Particularly, slightly, in the present context, means a maximum of 3 millimeters. A maximum of 1 millimeter can also be understood as slightly.

Alternatively, the secondary seal can be arranged as significantly/clearly set back from the end faces or protruding significantly/clearly beyond the end faces.

The secondary seal optionally comprises inorganic material, particularly alkali silicate, for intumescing/foaming up in case of a temperature rise in a fire and achieving at least part of the intumescent fire protection property of the secondary seal in this manner.

In other words, inorganic material in the secondary seal at least partially brings about the intumescent fire protection property of the secondary seal.

The inorganic material particularly comprises silicate and/or silicate salt.

Silicate and/or silicate salt alone, combined with each other, and/or in combination with other compounds can be used as the inorganic material having intumescent fire protection properties.

The following are listed as examples of silicate and/or silicate salt: aluminum silicate, lithium silicate, sodium silicate, compound of silicate and phosphate, compound of aluminum silicate and phosphate. For example, the inorganic material is alkali silicate. Other silicate derivatives can also be used.

For example, inorganic material that intumesces in case of fire foams up/intumesces because endothermic dehydrating (also referred to as dehydration) of the inorganic material takes place.

Water is released by the dehydrating, in the form of water vapor in case of fire. The water vapor forms gas bubbles ultimately forming a solid, rigid foam together with the molten, inorganic material.

The solid, rigid foam particularly comprises predominantly hydrated silicon dioxide. Predominantly means that the foam is made of at least 90 percent by weight of hydrated silicon dioxide. The foam is particularly made of at least 95 percent by weight of hydrated silicon dioxide. The foam can be particularly made of at least 98 percent by weight of hydrated silicon dioxide.

The intumescent fire protection property of the secondary seal can be based exclusively on inorganic material.

The secondary seal can comprise further material having the intumescent fire protection property in addition to inorganic material.

Alternatively, the secondary seal can be free of inorganic material having intumescent fire protection properties.

The secondary seal optionally comprises organic material that intumesces in case of a temperature rise in a fire and achieving at least part of the intumescent fire protection property of the secondary seal in this manner.

In other words, organic material in the secondary seal can at least partially bring about the intumescent fire protection property of the secondary seal.

Organic material in the secondary seal optionally intumesces in case of a temperature rise in a fire due to a chemical reaction of the organic material.

In other words, in case of fire, intumescent organic material foams up/intumesces because a chemical reaction takes place in the organic material.

Organic material that intumesces due to a chemical reaction optionally comprises the following materials: an acid source, a char former, a blowing agent, and a binder for binding the above materials.

An inorganic acid or a material from which an acidic or acid variant can arise serves as the acid source, for example.

A carbon-rich compound can be used as the char former. For example, polyvalent alcohols can be used. A particular weight portion of carbon in the char former can be deliberately selected, depending on the desired objective, in order to particularly achieve a particular structure of the carbon formed. A particular weight portion of hydroxyl in the char former can be deliberately selected, depending on the desired objective, in order to particularly achieve a particular carbonization speed (that is, the speed at which the charcoal is formed). The char former can optionally simultaneously serve as a binder.

The blowing agent is a compound, for example, for releasing a large amount of gas when decomposing. The blowing agent can be a halogenated and/or nitrous compound.

The binder binds together the acid source, the char former, and the blowing agent. The organic material particularly is not cohesive without a binder, and the intumescent fire protection property thereof loses efficiency without a binder. The binder can also simultaneously serve as the char former, for example.

The polymer-based matrix serves as the binder, for example. In other words, the examples named above for the polymer-based matrix are also examples for the binder. The binder thus comprises, for example, epoxide, polyurethane, silicone, polysulfide, acrylic, and/or a material forming a hot melt, such as butyl.

Examples of acid sources, char formers, and blowing agents are listed in the table below. The substances can be used alone or in combination.

| Acid source | Char former | Blowing agent |
|---|---|---|
| All compounds based | All compounds based | All compounds |
| on nitrogen and/or | on nitrogen and/or | based on nitrogen |
| phosphorus leading to | phosphorus leading | and/or phosphorus |
| an intumescent effect | to an intumescent | leading to an |
| in a sealant formulation. | effect in a sealant | intumescent effect |
| Some of the following | formulation. Some | in a sealant |
| compounds belong in | of the following | formulation. Some |
| this category. | compounds belong | of the following |
| Acids: | in this category. | compounds belong |
| phosphoric acid, | starch, dextrin, | in this category. |
| sulfuric acid, boric acid, | sorbitol, mannitol, | amines and the |
| red phosphorus | pentaerythritol as | salts thereof, |
| Ammonium salts: | a monomer, dimer, | urea and the |
| phosphates, | or trimer | salts thereof, |
| polyphosphates, | phenoplasts, | guanidine and the |
| borates, polyborates, | methylol melamines | salts thereof, |
| sulfates | coal forming | guanamines and |
| Phosphate salts of | polymers, such | salts thereof, |
| amines or amides: | as PA6 (poly- | amino acids and |
| reaction products of | caprolactam), | the salts thereof |
| urea or guanidine urea | polymer sheet | comprising 1,3,5- |
| with phosphoric acid, | silicate | triazine |
| melamine phosphate, | nanocomposite | Preferred salts |
| reaction products of | (“polymer clay | in this group |
| ammonia with P2O5 | nanocomposite”), | are phosphates, |
| Organic phosphorous | polyurethanes, | phosphonates, |
| compounds: | polycarbonates | phosphinates, |
| tricresylphosphate, | All of the binders | borates, sulfates, |
| alkyl phosphates, | indicated above, | and cyanates (e.g. |
| haloalkyl phosphates | particularly the | ammonium cyanate). |
| Other: | matrix. | cyan urea salts, |
| sulfites, nitrates, | | urea resins, |
| phosphonates, | | dicyandiamide |
| pentaerythritol | | melamine, chlorinated |
| phosphate alcohol | | paraffins, melamine |
| (PEPA) | | cyanuric acid adduct |

Alkyl thereby stands for monovalent alkane radicals of the general formula CₙH₂ₙ₊₁ (n=number of carbon atoms).

Haloalkyl is alkyl, for which at least one hydrogen atom has been replaced by a halogen atom.

For example, when the secondary seal is intumescing in case of fire due to a chemical reaction, the following process steps take place:
the acid source releases acid at a particular acid release temperature (the acid release temperature depends on the composition of the acid source and on other materials present in the secondary seal),
the acid esterifies the char former (that is, the acid reacts with hydroxyl groups of the char former) at temperatures slightly above the acid release temperature,
the part of the secondary seal in which the above process steps take place melts before or during the esterification,
the ester decomposes into a carbonaceous inorganic residue due to dehydration,
due to the process steps indicated above, gases and products of decomposition are released, forming gas bubbles and thereby leading to intumesce of the molten part of the secondary seal,
near the end of the chemical reactions of the process steps indicated above, gelation occurs, and finally solidification of the molten part of the secondary seal, resulting in a solid, rigid foam.

The gas bubbles formed in said resulting foam are thus enclosed in solid walls, wherein the walls comprise the carbonaceous inorganic residues. The foam formed has thermally insulating properties due to the residues.

Organic material in the secondary seal optionally is intumescenting in case of a temperature rise in a fire due to a physical reaction of the organic material.

In other words, in case of fire, intumescent organic material foams up/intumesces because a physically caused, particularly a mechanically caused, expansion takes place in the organic material.

The organic material optionally comprises exfoliated graphite.

The fact that the exfoliated graphite swells in case of fire and can demonstrate a thermally insulating effect in the expanded form thereof, is based on a physically caused expansion, and does not require any chemical reaction.

Exfoliated graphite can be used alone in the secondary seal.

Exfoliated graphite can also be used in the secondary seal with other material having intumescent fire protection properties.

For example, exfoliated graphite can be combined with material expanding due to a chemical reaction in case of fire.

Exfoliated graphite can be embedded in a matrix. The polymer-based matrix of the secondary seal serves as a matrix, and particularly the examples listed above for the polymer-based matrix. In case of fire, material escapes the matrix due to heat and/or the matrix expands.

For example, the intumescent organic material foams up/intumesces in case of fire both due to chemical reaction and due to physically caused expansion.

The intumescent fire protection property of the secondary seal can be based exclusively on organic material.

The secondary seal can comprise further material having the intumescent fire protection property in addition to organic material.

Alternatively, the secondary seal can be free of organic material having intumescent fire protection properties.

The secondary seal optionally comprises a material for releasing gas in case of fire and achieving at least part of the cooling fire protection property of the secondary seal in this manner.

The gas released by the secondary seal in case of fire can have the effect of reducing or eliminating oxygen available to the flames, and/or of diluting flammable and hot gas. The released gas can thus have a cooling effect, as said gas reduces or eliminates fuel and/or oxygen, and/or dilutes hot gases. For example, said cooling effect takes place in addition to a converting of thermal energy. The gas released by the secondary seal is water vapor or carbon dioxide, for example.

The secondary seal can alternatively be designed free of any gas releasing in case of fire.

Optionally, the secondary seal can release gas in case of fire due to the decomposition of a material of the secondary seal.

The gas releasing in case of fire due to decomposition of only one material of the secondary seal has the advantage that the material for decomposing can react alone, separately, in case of fire, independently of further components or materials of the secondary seal. The type of gas releasing is simple and failsafe. Only one single particular type of additional material is required for a corresponding type of secondary seal. A plurality of types of additional material having said property can also be used. One example of such a material is aluminum hydroxide (Al(OH₃) for decomposing and thereby releasing gas.

The secondary seal can alternatively be designed free of any gas releasing due to decomposition of material in the secondary seal in case of fire.

The secondary seal optionally releases gas in case of fire due to the decomposition of two or more materials of the secondary seal having gas release temperatures different from each other.

The gas releasing in case of fire due to decomposition of a plurality of materials of the secondary seal having different gas release temperatures has the advantage that, in case of fire, the gas releasing takes place over a wide range of temperatures.

The gas release temperature is the temperature above which a material releases gas (sometimes also referred to as the reaction temperature). The decomposing materials can be selected very specifically and combined for very particular application purposes and the corresponding temperature ranges.

For example, a specific selection and a specific mixture ratio of very particular materials can have particularly high gas release rates in a very particular temperature range not able to be covered by one material alone. Or as uniform a gas release rate as possible can be achieved in as wide a temperature range as possible.

For example, a specific selection and specific mixing ratio of very particular materials can release various particularly efficient gases in combination for an application case.

For example, the secondary seal can comprise Mg(OH)₂ on the one hand (at a gas release temperature of 320 degrees Celsius, wherein gas is released at up to 420 degrees Celsius) and, on the other hand, Ca(OH)₂ (at a gas release temperature of 400 degrees Celsius, wherein gas is released at up to 600 degrees Celsius).

Alternatively, the secondary seal is free of releasing gas in case of fire due to the decomposition of two or more materials of the secondary seal having gas release temperatures different from each other.

The secondary seal optionally comprises a material having endothermic properties for absorbing thermal energy in case of fire thanks to the endothermic properties thereof and achieving at least part of the cooling fire protection property of the secondary seal in this manner.

The endothermic property of the material in the secondary seal brings about an endothermic reaction in the secondary seal in case of fire. In this manner, thermal energy is extracted from the surrounding area of said material, having a cooling effect on the surrounding area of said material. Thus, a cooling effect is achieved in the secondary seal and all around the secondary seal. Huntite is one such material having endothermic properties, for example. An accumulation of hydromagnesite and huntite is another example.

The secondary seal can alternatively be designed free of any material having endothermic properties in case of fire.

The secondary seal can optionally comprise a synergistic material.

Synergistic material refers to a material bringing about a significant or even drastic reinforcement of an effect of the other material when added to another material (for example even in small amounts). Synergistic means that a combined effect of two materials is greater than a sum of effects of both materials alone.

With respect to the intumescent and/or cooling fire protection property, the following synergistic effects (alone or in combination) can particularly be achieved:
releasing more gas
endothermic decomposition
solid state diluent
reduction of an available amount of energy for polymer decomposition
improved thermal stability
forming and/or reinforcing the thermally insulating protective layer
improving the mechanical properties of the thermally insulating protective layer, particularly the char layer
improving the carbon quality with respect to thermal insulation of the char layer
changes to the carbon structure (nanostructure) in the char layer
increasing energy absorption
increasing the maximum amount of charred material in the secondary seal
improved flame resistance
smoke suppression
reducing the flammability or inflammability

Examples of potential synergistic materials for an intumescent and/or cooling fire protection property of the secondary seal can be found in the table below. Examples are listed therein of various materials suitable, alone or in combination with each other, for achieving a synergistic effect with respect to the intumescent and/or cooling fire protection property when added to the secondary seal. x thereby stands for any arbitrary number.

| | |
|---|---|
| Metal hydroxides | Al(OH)₃, Mg(OH)₂, Ca(OH)₂ |
| Oxides | MnO₂, ZnO, Ni₂O₃, Bi₂O₃, TiO₂, ZrO₂, |
| | Fe₂O₃ |
| | SnO₂, ZnSnO₃, ZnS, neodymium oxide |
| Other inorganic | Magnesium carbonate polyhydrate: |
| compounds | MgCO₃•xH₂O (x = 3: Magnesium |
| | carbonate trihydrate: MgCO₃•3H₂O |
| | (Nesquehonite), x = 4: |
| | Magnesium carbonate pentahydrate: |
| | MgCO₃•5H₂O (Lansfordite)) |
| | Mg5(CO₃)₄(OH)₂•xH₂O (x = 4: |
| | Hydromagnesite) |
| | Huntite: Mg₃Ca[CO₃]₄ |
| | Deposits of hydromagnesite and huntite |
| | (“ultracarb”) |
| | Magnesium phosphate polyhydrate: |
| | Mg₃(PO₄)₂•xH₂O |
| | Sodium acetate polyhydrate: |
| | CH₃COONa•xH₂O |
| | MgSO₄•xH₂O |
| | NaAI(OH)₂CO₃ (Dawsonite) |
| | Magnesium carbonate hydroxide |
| | pentahydrate: (MgCO₃)₄Mg(OH)₂•xH₂O |
| | (MCHP) |
| | Gypsum: CaSO₄•xH₂O |
| | Magnesium carbonate subhydrate |
| | Boehmite: AlO(OH) |
| | Magnesium chloride |
| | Magnesium sulfate |
| | Zinc sulfate |
| | Sodium bicarbonate |
| | Calcium carbonate |
| Boron compounds | Zinc borate |
| | Boron phosphate |
| | Boron siloxane |
| | B₂O₃ |
| | Boric acid |
| Phosphorous compounds | Phosphazene |
| | ZrPO₄ |
| Silicon compounds | Silicon dioxide (silicic acid), silicone, |
| | silicalite |
| Aluminum silicates | Mordenite, zeolite, montmorillonite |
| Metal chelates | Ni-, Co-, Cu-chelates |
| Exfoliated graphite | |
| Aerogels | |
| Other | Carbon nanotubes, silsesquioxane, |
| | layered double hydroxides, Cu, Pt, talc, |
| | sepiolite, zinc and nickel salts; |
| | salicylaldehyde, salicylaldoxime, borate |
| | (colemanite), lanthanum oxide |
| | ZnS, ZnSn(OH)₆, ZHS |
| | Cerium phosphate |
| | Iron |
| | Basalt fibers |
| | Citric acid |
| | Vermiculite |
| | Polymeric ceram (St. Gobain patent) |

The secondary seal optionally comprises a fire-suppressing material for reducing a portion of further material in the secondary seal.

In other words, a fire-suppressing material is added to the secondary seal, the presence thereof reducing a portion of dangerous fire material in the secondary seal. Thus by introducing fire-suppressing material, a quantity of another, less fire-suppressing, material in the secondary seal is reduced (solid state diluent). Fire-suppressing, in this context, means that the material itself is not flammable and in case of fire, for example, releases no or little flammable gases or materials.

The material used as the solid-state diluent can achieve a synergistic effect with respect to material having an intumescent and/or cooling fire protection property.

For example, an aerogel can be used as a solid-state diluent in the secondary seal.

Alternatively, the secondary seal can be free of any fire-suppressing material acting as a solid-state diluent.

The secondary seal optionally comprises a material forming a thermally insulating protective layer in case of fire.

Such a thermally insulating protective layer can achieve a synergistic effect with respect to material having an intumescent and/or cooling fire protection property.

Forming a thermally insulating protective layer in case of fire has the effect that flames and heat are suppressed by the protective layer. Such a protective layer in the secondary seal can particularly minimize or prevent flames and/or heat from penetrating from the edges of the fire protection glazing in an intermediate space between the fire protection glazing and the surrounding area thereof. Less heat and/or flames reduces decomposition, due to temperature, of the fire protection material, for example, and/or of the spacer in the intermediate space.

The thermally insulating protective layer is particularly a char layer.

Alternatively, the secondary seal is free of any material forming a thermally insulating protective layer in case of fire.

The secondary seal can alternatively be designed free of any synergistic material.

The optional features can be present alone or combined in the fire protection glazing according to the invention.

### BRIEF DESCRIPTION OF THE DRAWINGS

The object of the invention is explained in further detail below using a preferred embodiment example shown in the attached drawings. They show, schematically in each case:

FIG. 1 a section side view through a top part of a fire protection glazing according to the invention;

FIG. 2 the fire protection glazing from FIG. 1 in the same view, installed in a frame;

FIG. 3 temperature curve of a test measurement.

### DETAILED DESCRIPTION OF THE INVENTION

Identical parts in the figures are fundamentally referenced with the same reference numeral.

The designations left, right, top, and bottom relate to the plane of the drawing in the figures.

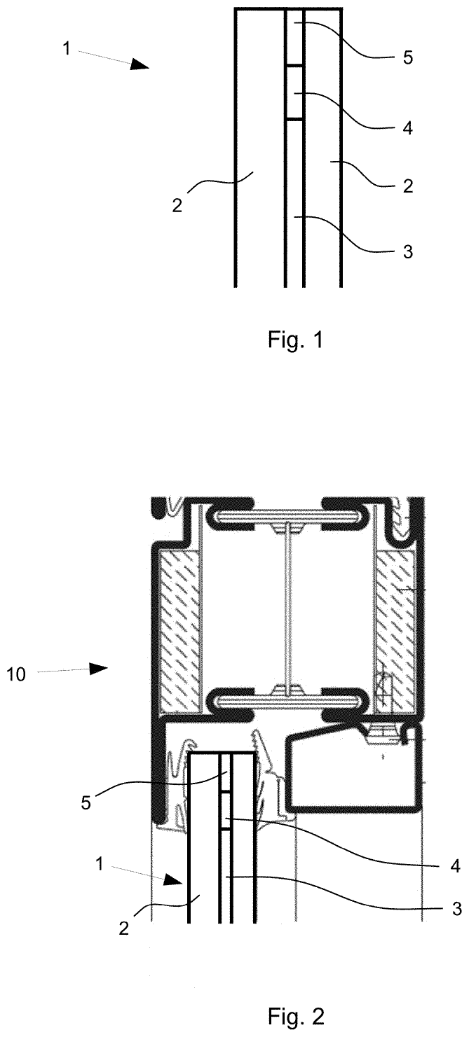

FIGS. 1 and 2 show the same embodiment example of the fire protection glazing 1 according to the invention. In both FIGS. 1 and 2, a section side view is shown in each case. In addition, both figures of the fire protection glazing 1 show only the top part. That is, from a perpendicularly positioned fire protection glazing 1 (that is, aligned parallel to the direction of gravity), the top part or, in other words, a top end of the fire protection glazing 1 is shown. Other edge regions of the fire protection glazing 1 are designed similarly. The same applies to the frame 10 in FIG. 2: only the top part of the frame 10 is shown. The other parts are designed analogously.

A part of the fire protection glazing 1 is shown in FIG. 1. Two glass panes 2 arranged in parallel are spaced apart from each other by a spacer 4 arranged between said panes. A fire protection material 3 is present between the two glass panes 2 and below the spacer 4. A secondary seal 5 is arranged entirely between the two glass panes 2 and above the spacer 4. The secondary seal 5 ends at the top flush with end faces of the two glass panes 2.

The fire protection glazing from FIG. 1 is shown in FIG. 2 in the same view, but now installed in a frame 10. It can be clearly seen in FIG. 2 that the fire protection properties of the fire protection glazing 1 are particularly significant at the edges thereof (only the top edge is shown here). In the edge region of the fire protection glazing 1, where the secondary seal 5 is present, a thermally insulating foam (not shown) can, in case of fire, have a sealing and insulating effect between the fire protection glazing 1 and frame 10 for the installed fire protection glazing 1, where weak points are present due to the design. In addition, gas can also be released and have a diluting and cooling effect, and/or thermal energy can be converted, precisely at said location. This is particularly the case at the top edge of the fire protection glazing 1, where particularly difficult circumstances prevail due to convection in case of fire (high levels of heat, flames, smoke) and good fire protection properties are particularly advantageous and helpful.

A first embodiment of the secondary seal 5 is made of epoxy (matrix and binder) and 25 weight percent of APP (ammonium polyphosphate, an acid source), 6 weight percent PER (pentaerythritol, a char former), 10 weight percent of mel (melamine, a blowing agent), 4 weight percent of aluminum trihydroxide (has a cooling fire protection effect), and 5 weight percent of titanium dioxide (having a stabilizing effect on the foam). In the present first embodiment, the secondary seal 5 is intumescing due to a chemical reaction, and additionally the secondary seal has an active cooling effect due to the titanium dioxide.

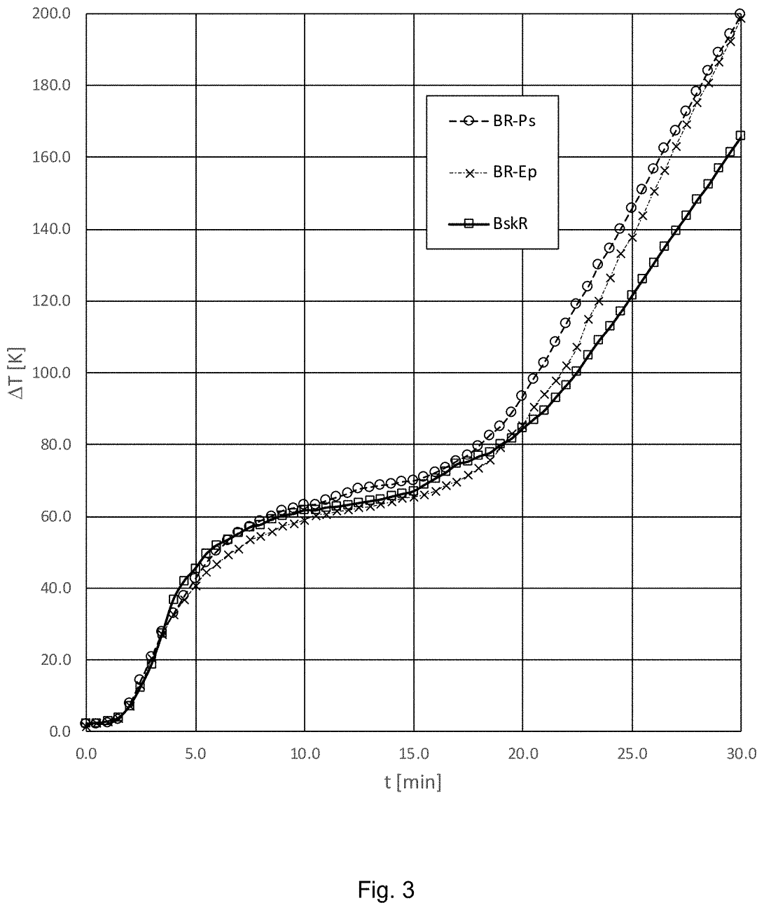

FIG. 3 shows the results of a benchmark test. A temperature increase ΔT within 30 minutes was measured on the side of the tested fire protection glazing facing away from the fire, outside the mounting element at a top corner of the fire protection glazing. The corresponding temperature increases are shown in FIG. 3: the temperature increase ΔT (in Kelvin) on the side facing away from the fire (cold side) of the fire protection glazing is shown as a function of time t (in minutes), from which the fire resistance duration can be derived.

The benchmark test was performed on model CF30 fire protection glazing, mounted in the same mounting element (Janisol II frame system having EPDM seals). The mounting element comprises no additional cooling and/or intumescent element. Only the secondary seal was varied. The second embodiment of the fire protection glazing BskR according to the invention used in the benchmark test has a secondary seal made of the materials of the table below, which accounted for its intumescent and cooling fire protection effect thereof. Measured values of said fire protection glazing BskR are shown in FIG. 3 as open squares connected by a continuous line.

| Product | Weight percent (wt %) |
|---|---|
| DGEBA (bisphenol-A-diglycidyl ether | 26.05 |
| D3415 by Sigma Aldrich) | |
| D400 + D2000 (D400 = poly(propylene | 23.95 |
| glycol) bis(2-aminopropyl ether), Mn = | |
| 400 g/mol. 406678 by Sigma Aldrich | |
| (hardener); D2000 = poly(propylene | |
| glycol) bis(2-aminopropyl ether), Mn = | |
| 2000 g/mol. 406686 by Sigma Aldrich | |
| (hardener) | |
| AP750 ammonium polyphosphate by | 25 |
| Clariant | |
| Charmor PM15 pentaerythritol by | 6 |
| Perstorp | |
| Melamine by Sigma Aldrich | 10 |
| Martinal ON-320 | 4 |
| (Aluminum trihydroxide Al(OH)₃ by | |
| Huber Martinswerk, Bergheim) | |
| TiO₂ by Chemours | 5 |

Two different secondary seals without any intumescent or any cooling fire protection property were tested for comparison: one was made of pure polysulfide; another was made of pure epoxy. Measured values of the BR-Ps fire protection glazing having the secondary seal made of pure polysulfide are shown in FIG. 3 as open circles connected by a dashed line. Measured values for the BR-Ep fire protection glazing having the secondary seal made of pure epoxy are shown in FIG. 3 as crosses connected by a dashed-dotted line.

As can be seen, the temperature increases for the fire protection glazings of all three secondary seals are fairly similar for about 20 minutes, then the fire protection glazing BskR having the secondary seal having intumescent and cooling fire protection properties shows significantly lower values of temperature increase. After thirty minutes, the fire protection glazing BskR having the secondary seal according to the invention having intumescent and cooling fire protection properties shows a temperature increase of 33 Kelvin less than the BR-Ps and BR-Ep fire protection glazings having the other two secondary seals.

The temperature increase for the BR-Ps and BR-Ep fire protection glazings after 30 minutes is 199.5 Kelvin and 198.67 respectively. The two fire protection glazings having the secondary seals without intumescent and without cooling fire protection properties are thus not able to achieve any of the fire protection effect according to the EI 30 standard, unless further measures are taken (such as the use of additional intumescent and/or cooling bands). The variant of the fire protection glazing BskR according to the invention having the secondary seal having intumescent and cooling fire protection properties, in contrast, easily allows a fire protection effect according to the EI 30 standard to be achieved together with the tested mounting element, without additional measures needing to be taken. This is because the temperature increase of the tested fire protection glazing BskR according to the invention after 30 minutes is only 165.75 Kelvin, and thus is 14.25 Kelvin below the maximum allowable value in the EI 30 standard of 180 Kelvin.

1. A fire protection glazing made of two or more glass panes spaced apart from each other by a spacer, a fire protection material and the spacer being arranged in an intermediate space between the two glass panes, secondary seal enclosing the fire protection material and the spacer in the intermediate space,
wherein the secondary seal has an intumescent fire protection property and a cooling fire protection property.

2. The fire protection glazing according to claim 1, wherein the secondary seal is an element for immovably attaching the glass panes spaced apart by the spacer to each other.

3. The fire protection glazing according to claim 1, wherein the secondary seal is different from the spacer.

4. The fire protection glazing according to claim 1, wherein the secondary seal is designed as a single element.

5. The fire protection glazing according to claim 1 wherein, exclusively the fire protection material, the spacer, having a spacer attachment for attaching the spacer to the glass pane, and the secondary seal are arranged in the intermediate space between the two glass panes.

6. The fire protection glazing according to claim 1, wherein the secondary seal is arranged in a region of the intermediate space adjacent to the end faces of the glass panes.

7. The fire protection glazing according to claim 1, wherein the secondary seal comprises inorganic material, particularly alkali silicate, which intumesces when a temperature rises in the event of a fire and in this manner achieves at least part of the intumescent fire protection property of the secondary seal.

8. The fire protection glazing according to claim 1, wherein the secondary seal comprises organic material which intumesces when a temperature rises in the event of a fire and in this manner achieves at least part of the intumescent fire protection property of the secondary seal.

9. The fire protection glazing according to claim 8, wherein the organic material in the secondary seal is intumescent in case of a temperature rise in a fire due to a chemical reaction of the organic material.

10. The fire protection glazing according to claim 9, wherein the organic material is intumescent due to a chemical reaction comprises the following materials: an acid source, a char former, a blowing agent, and a binder for binding the above-mentioned materials.

11. The fire protection glazing according to claim 8, wherein the organic material in the secondary seal is intumescent in case of a temperature rise in a fire due to a physical reaction of the organic material.

12. The fire protection glazing according to claim 11, wherein the organic material comprises exfoliated graphite.

13. The fire protection glazing according to claim 1, wherein the secondary seal comprises a material which releases gas in the event of fire and in this manner achieves that at least part of the cooling fire protection property of the secondary seal.

14. The fire protection glazing according to claim 13, wherein the secondary seal releases gas in case of fire due to decomposition of the material of the secondary seal.

15. The fire protection glazing according to claim 13, wherein seal releases gas in case of fire due to the decomposition of two or more materials of the secondary seal which have different gas release temperatures.

16. The fire protection glazing according to claim 1, wherein the secondary seal comprises a material having endothermic properties which, in the event of fire, absorbs thermal energy thanks to its endothermic properties and in this manner achieves at least part of the cooling fire protection property of the secondary seal.

17. The fire protection glazing according to claim 1, wherein the secondary seal comprises a synergistic material.

18. The fire protection glazing according to claim 1, wherein the secondary seal comprises a fire-suppressing material for reducing a portion of further material in the secondary seal.
